(19) United States
(12) Patent Application Publication
(10) Pub. No.: US 2021/0148711 A1
(43) Pub. Date: May 20, 2021

(54) MAP UPDATING METHOD AND APPARATUS, AND STORAGE MEDIUM

(71) Applicant: BEIJING BAIDU NETCOM SCIENCE AND TECHNOLOGY CO., LTD., Beijing (CN)

(72) Inventors: Peng SUN, Beijing (CN); Changjie MA, Beijing (CN); Dangen SHE, Beijing (CN); Shuquan ZOU, Beijing (CN)

(73) Assignee: BEIJING BAIDU NETCOM SCIENCE AND TECHNOLOGY CO., LTD.

(21) Appl. No.: 17/078,724

(22) Filed: Oct. 23, 2020

(30) Foreign Application Priority Data
Nov. 20, 2019 (CN) 201911140496.1

(51) Int. Cl. G01C 21/32; G06K 9/00; B60W 40/06

(52) U.S. Cl. CPC G01C 21/32; G06K 9/00798; B60W 2552/53; B60W 2556/40; B60W 40/06

(57) ABSTRACT

Example embodiments of the present disclosure provide a map updating method and apparatus, a device and a computer-readable storage medium, which may be applied to a field of autonomous driving. The map updating method includes determining that there is an interruption on a road edge of a road on a map, the road edge representing a boundary of a part of the road available for vehicles. The method further includes determining, based on the map, a reference distance between an existing part of the road edge and a division line, the existing part being within a predetermined distance from the interruption, and the division line representing a division between different traveling directions of the road. The method further includes generating a supplementary part for the interruption on the map based on the reference distance and the division line.

### CROSS-REFERENCE TO RELATED APPLICATION

The present application is based upon and claims priority to Chinese Patent Application No. 201911140496.1, filed on Nov. 20, 2019, the entirety contents of which are incorporated herein by reference.

### FIELD

Embodiments of the present disclosure mainly relate to a field of computers, may be applied to autonomous driving, and more particularly, relate to a map updating method and apparatus, and a computer-readable storage medium.

### BACKGROUND

A high-definition map is a machine-oriented digital map that can be applied to, for example, autonomous driving, robot navigation, and positioning. The high-definition map plays an important role in autonomous driving systems. In the entire driving system, sensing, path planning and positioning system all rely on the high-definition map to work to varying degrees.

The high-definition map is a map of high accuracy, which not only has high accuracy, but also includes information that can be used for precise navigation and positioning, such as various information (e.g., lane lines, guardrail lines, and road edges) about roads. For some special road segments, such as a median opening (an opening of a median divider), part(s) of a road edge may be missing. In order to ensure autonomous vehicles to use high-definition maps efficiently and safely, it is necessary to complete missing parts of the road edge.

### SUMMARY

According to exemplary embodiments of the present disclosure, solutions for map updating are provided.

In embodiments of the present disclosure, a map updating method is provided. The method includes determining that there is an interruption on a road edge of a road on a map, in which the road edge represents a boundary of a part of the road available for vehicles; determining, based on the map, a reference distance between an existing part of the road edge and a division line, in which the existing part is within a predetermined distance from the interruption, and the division line represents a division between different traveling directions of the road; and generating a supplementary part for the interruption on the map based on the reference distance and the division line.

In embodiments of the present disclosure, a map updating apparatus is provided. The apparatus includes one or more processors; a memory storing instructions executable by the one or more processors; in which the one or more processors are configured to: determine that there is an interruption on a road edge of a road on a map, in which the road edge represents a boundary of a part of the road available for vehicles; determine, based on the map, a reference distance between an existing part of the road edge and a division line, in which the existing part is within a predetermined distance from the interruption, and the division line represents a division between different traveling directions of the road; generate a supplementary part for the interruption on the map based on the reference distance and the division line.

In embodiments of the present disclosure, a non-transitory computer-readable storage medium having a computer program stored thereon is provided. When the program is executed by a processor, a map updating method according to the present disclosure is implemented. The method may include: determining that there is an interruption on a road edge of a road on a map, in which the road edge represents a boundary of a part of the road available for vehicles; determining, based on the map, a reference distance between an existing part of the road edge and a division line, in which the existing part is within a predetermined distance from the interruption, and the division line represents a division between different traveling directions of the road; and generating a supplementary part for the interruption on the map based on the reference distance and the division line.

It should be understood that the Summary of the present disclosure is not intended to define key or important features of embodiments of the present disclosure, nor is it intended to limit the scope of the present disclosure. Other features of the present disclosure will become easier to be understood through the following description.

### BRIEF DESCRIPTION OF THE DRAWINGS

The above and other features, advantages and aspects of embodiments of the present disclosure will become more apparent in combination with the accompanying drawings and with reference to the following detailed description. The same or similar reference numerals in the accompanying drawings indicate the same or similar elements.

FIG. 1 is a schematic diagram of an example environment in which some embodiments of the present disclosure may be implemented.

FIG. 2 is a flowchart of a process of updating a map according to some embodiments of the present disclosure.

FIG. 3 is a flowchart of a process of determining a reference distance according to some embodiments of the present disclosure.

FIG. 4A is a schematic diagram of determining sampling points according to some embodiments of the present disclosure.

FIG. 4B is a schematic diagram of determined sampling points according to some embodiments of the present disclosure.

FIG. 4C is a schematic diagram of determining a sampling distance according to some embodiments of the present disclosure.

FIG. 4D is a schematic diagram of determined sampling distances according to some embodiments of the present disclosure.

FIG. 5 is a schematic diagram of generating a supplementary part according to some embodiments of the present disclosure.

FIG. 6 is a schematic diagram of an updated map according to some embodiments of the present disclosure.

FIG. 7 is a block diagram of a map updating apparatus according to some embodiments of the present disclosure.

FIG. 8 is a block diagram of a computing device capable of implementing various embodiments of the present disclosure.

### DETAILED DESCRIPTION

Embodiments of the present disclosure will be described in more detail below with reference to the accompanying drawings. While some embodiments of the present disclosure have been illustrated in the accompanying drawings, it is to be understood that the present disclosure may be embodied in various forms and should not be construed as limited to the embodiments set forth herein; instead, these embodiments are provided so that the present disclosure will be understood thoroughly and completely. It should be understood that the drawings and embodiments of the present disclosure are for illustrative purposes only and are not intended to limit the scope of the present disclosure.

In the description of the embodiments of the present disclosure, the term “include” and its equivalents should be construed as open-ended inclusions, i.e., “including, but not limited to”. The term “based on” should be understood as “at least partially based on”. The term “one embodiment” or “the embodiment” should be understood as “at least one embodiment”. Terms “first,” “second,” and the like may refer to different or identical objects. Other explicit and implicit definitions may also be included below.

As mentioned above, a high-definition map includes various kinds of information, such as lane lines, guardrail lines, and road edges, about roads. A “lane line” refers to a solid or dashed line on a road that separates different lanes. The definition of a “road edge” on both sides of a road is not given in Design Specification for Highway Alignment, but in Section 4.2.5.1, “Lane Edge”, in Intelligent Transportation System—Intelligent Map Data Model & Exchange Format Specification—Part 1: Motorway (draft for comments) gives production principles of a “road edge”. According to the production principles, if there is a curb, “when there is no lane line on the outermost side of a road, a line may be drawn along an intersecting line of the curb and the ground as the outermost lane line of the road”. For the geometric shape of curbs, reference may be made to the section G.2, Cross Section Shapes in Concrete Curbs—JCT 899-2016. In practice, road edges and guardrail lines are usually provided at the same time in a high-definition map. The production principle of the road edge is “drawing along the intersecting line of the curb and the ground”. The production principle of a guardrail line is “drawing along an intersecting line of the guardrail and the ground”.

However, regarding the “median opening” defined in Section 6.3.3 of Design Specification for Highway Alignment, according to the production principles of the “road edge” provided in the Intelligent Transportation System—Intelligent Map Data Model & Exchange Format Specification—Part 1: Motorway (draft for comments), only production principle b) “drawing along the intersecting line of the guardrail and the ground” or c) “drawing at edges of a road when edges of the road are particularly visible” defined in section 4.2.5.1 are suitable. Since the “road edge” cannot be drawn with the production principle b) or the c), the “road edge” at the “median opening” will inevitably interrupted.

In practical applications, the autonomous driving system needs to calculate a “road boundary” based on both the “road edge” and the “guardrail line”. In other words, if the curb is outside the guardrail, the curb serves as the road boundary; and if the guardrail is outside the curb, the guardrail serves as the road boundary. At the “median opening”, the guardrail is a movable guardrail. In this case, the “guardrail line” which is “drawn along the intersecting line of the guardrail and the ground” only provides information on the intersecting line of the guardrail and the ground, without considering geometric information of an upper part of the movable guardrail. In this case, if the “guardrail line” is simply determined as the “road boundary”, accidents are very likely to happen when the upper part of the movable guardrail tilts toward the inside of a road. Although the autonomous driving system may make strict lateral clearance for the “guardrail line” at the “median opening”, there is no doubt that complicated calculations are required.

Therefore, in terms of completing or generating the “road edge” interrupted at the “median opening”, a manner of making full use of the lateral clearance of the “road edge” that is stricter than the conventional lateral clearance of the “guardrail line” may improve the safety of the autonomous driving system and reduce the calculation complexity of the lateral clearance at the “median opening” of the motorway. Consequently, the manner has great practical value.

Conventionally, there are two solutions to generate or complete the road edge at the “median opening” of a road. The first solution relies on manual processing. In the process of producing high-definition maps, the road edge at the “median opening” is manually generated and completed. Original data that may be referred to during manual processing is: laser point cloud, continuous frames of images and other data of the guardrail (or mobile guardrail) at the “median opening”. On the basis of the guardrail line obtained with reference to the above data, an operation such as manually selecting points inside the guardrail line is performed to smoothly generate or complete the road edge at the “median opening”. The accuracy of manual operations depends largely on experience of workers.

Although manual processing may make full use of rich fusion information of vision and lidar and may obtain a reasonable road edge in combination with human experience, shortcomings of manual processing are also obvious. One shortcoming is that the operation efficiency is low, and thus it is impossible to process “median openings” of roads nationwide manually. In addition, manual operations cannot guarantee the accuracy of each worker. Since the accuracy of manual operations largely depends on personal experience, large errors may be generated when the original data is insufficient or images of some segments are blurred.

The second solution uses an average width of a marginal strip at the rear (relative to a traveling direction of a vehicle on a road) to calculate the road edge. In automated processing, a direct method is to collect widths of the marginal strip behind the “median opening” (in actual calculation, vertical distances from the road edge to the leftmost lane line may be used) to obtain a statistical value, for example, an average value. The average value is used as a reference calculation value of the “road edge” at the “median opening” to obtain the road edge of the “median opening”. An algorithmic basis of this method is a fact that the “median opening” also belongs to a “median”, and there is also a “marginal strip” between the “median opening” and the leftmost lane line. A part of the “marginal strip” of the “median opening” that may be used by the autonomous driving system is a natural extension of the identified “marginal strip” at the rear.

Although the concept of an extension of the “marginal strip” is used, the solution is somewhat conservative as there is much space in the “median opening” for autonomous vehicles to use in emergency situations. The road edge completed through the solution greatly wastes the spare lateral clearance of the road. In addition, the solution also fails to fully consider an actual position of the movable guardrail in the middle of the road. In some cases, the movable guardrail is very close to edges of the extended marginal strip, which may produce potential safety risks.

In view of the above, a stable and safe method is needed to complete missing parts of the road edge in the high-definition maps. Through observation and experiments, the inventor of the present disclosure found that a distance (which may be expressed as d_gc herein) from the guardrail line to the road edge is relatively stable. For example, statistical results of some urban expressway show that an average value of d_gc is 0.30 meters. If samples in a range of 0.22-0.38 meters account for 89.3% of total samples, and samples in a range of 0.15-0.45 meters account for 99.1% of the total samples, it may be understood that 99.1% of distances from the guardrail line to the road edge are within a range of 0.3±0.15 meters. The inventor of the present disclosure realized that the road edge at the “median opening” may be generated based on distances from the guardrail line to the road edge within a certain distance on both sides of the “median opening”.

According to embodiments of the present disclosure, a solution for map updating is provided. In this solution, when the road edge on the map is interrupted, an existing part and a division line (e.g., the guardrail line) within a certain distance from an interruption are used to determine a reference distance (e.g., an average distance) for the interruption. Based on the reference distance and the division line, a supplementary part of the road edge for the interruption may be generated on the map. Therefore, the solution of the present disclosure may automatically and efficiently supplement originally missing parts of the road edge on the map. In this manner, the map may be updated steadily, and the updated map may provide road users (e.g., autonomous vehicles) with safe road information.

Hereinafter, some embodiments of the present disclosure will be described in detail with reference to the accompanying drawings.

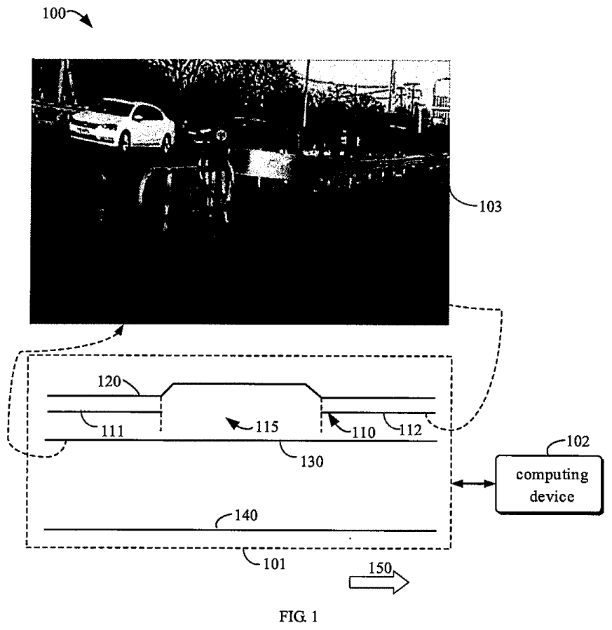

FIG. 1 is a schematic diagram of an example environment 100 in which some embodiments of the present disclosure may be implemented. In this example environment 100, a map 101 is processed by a computing device 102. The computing device 102 may read the map 101 locally or from other devices, and use existing data of the map 101 to update the map 101, for example to supplement missing information about roads. It should be understood that the environment 100 illustrated in FIG. 1 is merely exemplary, and the map 101 may also be processed using a plurality of computing devices.

The computing device 102 may be any device with computing capabilities. As a non-limiting example, the computing device 102 may be any type of fixed computing device, mobile computing device, or portable computing device, including but not limited to a desktop computer, a laptop computer, a notebook computer, a netbook computer, a tablet computer, a multimedia computer, a mobile phone, and so on. All or part of components of the computing device 102 may be distributed in a cloud.

In some embodiments, the computing device 102 may be an electronic device that is independent of road users (e.g., autonomous vehicles). In this case, the solution for map updating disclosed in the present disclosure may be executed during the map production process. In some embodiments, the computing device 102 may be associated with road users, for example, may be deployed in autonomous vehicles. In this case, the solution of map updating disclosed herein may be executed before or during the use of a road performed by the road users.

It should be understood that only a part of the map 101 is illustrated schematically in FIG. 1. As illustrated in FIG. 1, the map 101 includes a lane line 130, a lane line 140, a road edge 110 and a division line 120. In order to better understand the solution of the present disclosure, a corresponding relationship between the lane line 130 and the road edge 110 and elements in an example image 103 is illustrated in FIG. 1. It should be understood that the example image 103 is provided only to illustrate embodiments of the present disclosure and is not intended to limit the present disclosure.

The division line 120 is configured to separate different traveling directions of a road. For example, the division line 120 may be the guardrail line described above, that is, a line drawn along the intersecting line of the guardrail and the ground. In the example of FIG. 1, the division line 120 is illustrated as having a protruding portion, but such an illustration is only exemplary. The division line 120 may be similar to the lane line 130 and is substantially straight.

The road edge 110 represents a boundary of a part of the road available for vehicles. The “available for vehicles” mentioned herein includes available for vehicles under normal conditions and emergencies such as parking in an emergency or avoiding other vehicles. As schematically illustrated in FIG. 1, the road edge 110 may represent a boundary of a curb located at the center of the road. In some other examples, the road edge 110 may represent a boundary of an object (e.g., a curb) that protrudes from the ground in other forms.

In some cases, there may be an interruption on the road edge. For example, an interruption occurs at a median opening illustrated in the example image 103. In the example of FIG. 1, the road edge 110 is interrupted at an interruption 115 (for example, the median opening), and thus is divided into two consecutive segments on two sides of the interruption 115, respectively, which are referred to herein as a first segment 111 and a second segment 112. In the example of FIG. 1, along a traveling direction 150, the first segment 111 is located behind the interruption 115 and the second segment 112 is located before the interruption 115.

The computing device 102 may generate a missing part of the road edge 110, thereby updating the map 101. The computing device 102 may generate an additional part of the road edge 110 for the interruption 115 based on a distance from the division line 120 on one or both sides of the interruption 115 within a certain distance to the road edge 110. For example, in a case of the example image 103, the computing device 102 may generate the road edge at the “median opening” based on a distance from guardrail lines on both sides of the “median opening” within a certain distance to the road edge.

In order to more clearly understand the solution of map updating provided by the present disclosure, some embodiments of the present disclosure will be further described with reference to FIG. 2. FIG. 2 is a flowchart of a process 200 of updating a map according to some embodiments of the present disclosure. The process 200 may be implemented by the computing device 102 illustrated in FIG. 1, For ease of discussion, the process 200 will be described in combination with FIG. 1.

At block 210, the computing device 102 determines that there is an interruption 115 on a road edge 110 of a road on a map 101. The road edge 110 represents a boundary of a part of the road for vehicles to use. For example, at least a part of the road edge 110 is determined based on the curb, and represents an intersecting line of the inner side of the curb and the ground. The interruption 115 may occur, for example, due to the median opening illustrated in FIG. 1. The interruption 115 may also be caused by other reasons. For example, a boundary of the curb is not recognized for some reason.

At block 220, the computing device 102 determines, based on the map 101, a reference distance between an existing part of the road edge 110 and a division line 120. The existing part is within a predetermined distance from the interruption 115, and the division line 120 represents a division between different traveling directions of the road. For example, the division line 120 may represent an intersecting line of a guardrail in the center of a road and the ground. In this case, the division line 120 may be the guardrail line.

In some embodiments, the existing part of the road edge 110 under consideration may include at least a part of two consecutive segments on two sides of the interruption 115, respectively. For example, the existing part may include a part of the first segment 111 within a predetermined range from the interruption 115, and the first segment 111 is located behind the interruption 115 along the traveling direction 150 of the road. The existing part may also include a part of the second segment 112 within a predetermined range from the interruption 115, and the second segment 112 is located in front of the interruption 115 along the traveling direction 150. In such an embodiment, since information on both sides of the interruption 115 is taken into account, the supplementary part (described below with reference to block 230) generated for the interruption 115 will have satisfying smoothness.

In some embodiments, the existing part considered may include only a part located in front of or behind the interruption 115. For example, the existing part considered may include only a part of the first segment 111 within the predetermined range from the interruption 115.

The existing part of the road edge 110 considered may be within the predetermined range from the interruption 115, for example, within a certain distance from the interruption 115. For example, the existing part may include a part of the first segment 111 within a predetermined distance from the left end point of the interruption 115. The existing part may also include a part of the second segment 112 within a predetermined distance from the right end point of the interruption 115.

The predetermined distance may be determined based on road conditions. As an example, the predetermined distance may be, for example, 60 meters. The reason for choosing the road edge within the range of 60 meters is that Section 6.3.3 of Design Specification for Highway Alignment stipulates that “a distance between median openings shall be determined as necessary, and the minimum distance shall not be less than 2 km”. Therefore, a distance selected on one or both sides of the interruption should not be greater than 2 km. In addition, considering the calculation efficiency, the inventor of the present disclosure realized that selecting 60 meters as the predetermined range may take into account both efficiency and statistical representativeness. It should be understood that 60 meters is only one example of the predetermined distance or predetermined range. In embodiments of the present disclosure, an appropriate predetermined range or predetermined distance may be selected as needed.

The reference distance may represent an average distance between the road edge 110 within a predetermined range from the interruption 115 and the division line 120. The computing device 102 may employ various suitable methods to determine the reference distance. In some embodiments, the computing device 102 may employ geometric means to determine the reference distance. For example, the computing device 102 may consider a geometric shape (e.g., a rectangle) formed by the selected existing part and a part of the division line 120 corresponding to the existing part. The reference distance is determined based on an area or a volume (in a case of a three-dimension shape) of the geometric shape and a length of the predetermined range selected.

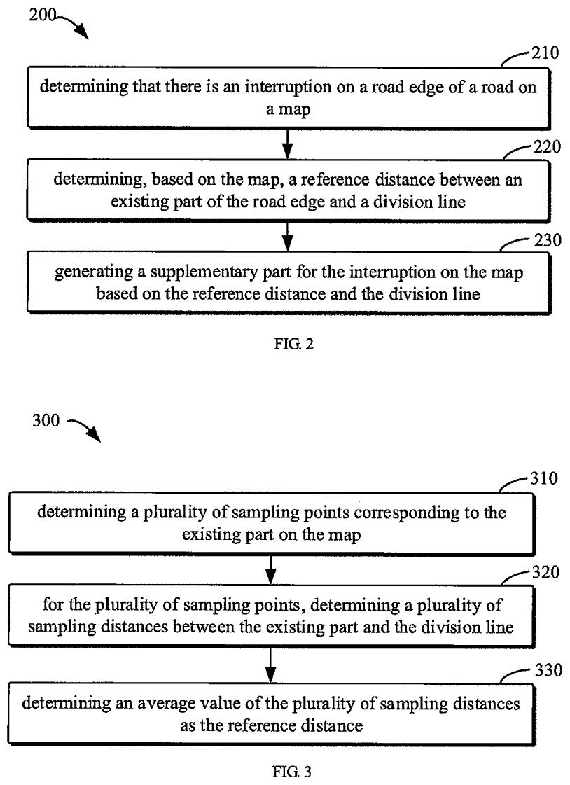

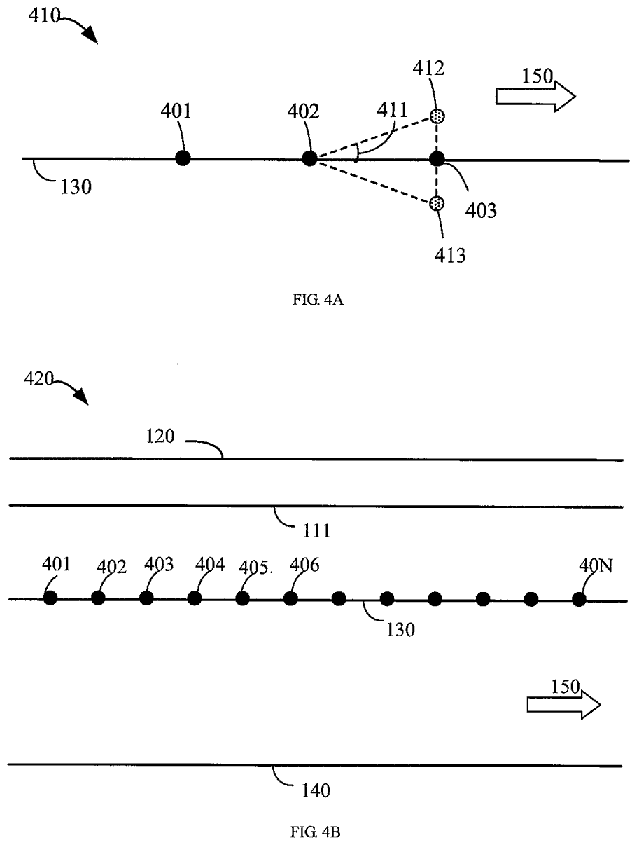

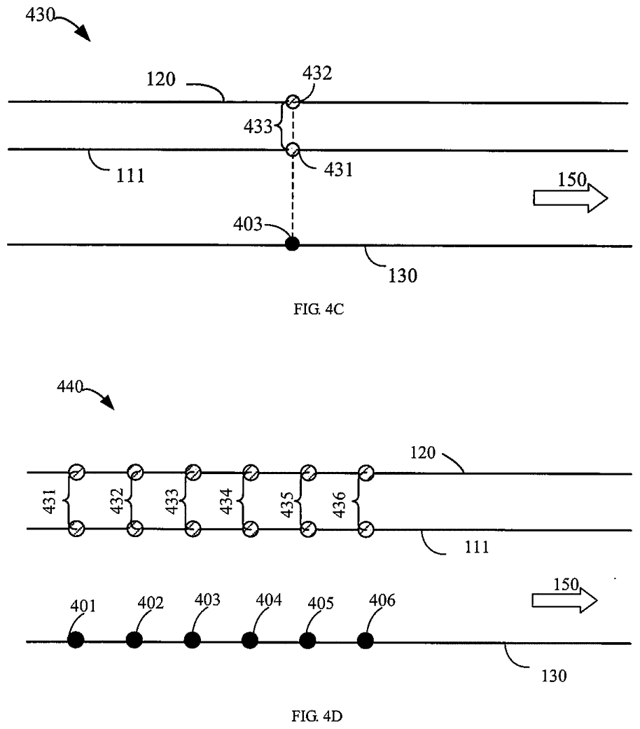

In some embodiments, the computing device 102 may determine the reference distance based on sampling points. Some of such embodiments will be described below with reference to FIGS. 3 and 4A-4D.

At block 230, the computing device 102 generates a supplementary part for the interruption 115 on the map 101 based on the reference distance and the division line 120. In other words, at block 230, the computing device 102 may generate a part of the road edge 110 that was originally missing. In some embodiments, the computing device 102 may draw the supplementary part in a geometrically continuous manner based on the division line 120 and the reference distance (e.g., the average distance) determined at block 220, that is, draw a part of the road edge 110 corresponding to the interruption 115. In some embodiments, as will be described further below with reference to FIG. 5, the computing device 102 may use fitting points to generate the supplementary part based on the division line 120 and the reference distance.

The map updating method according to embodiments of the present disclosure has been described above with reference to FIG. 2. With the solution of the present disclosure, a part, for example, a missing part due to a median opening, of the road edge that was originally missing may be generated. Road edges and maps updated in this manner have better stability, for the reason that the basis of the solution is the characteristic that a distance from the division line (e.g., the guardrail line) to the road edge is relatively stable. In fact, it is also because that a width of the curb is relatively stable. Therefore, the solution is stable in terms of large-scale (such as nationwide) production of high-definition maps.

In addition, road edges and maps updated in this manner may bring higher safety. The solution is a manner of leaving lateral clearance toward the inside of the road based on the road edge. When the solution is actually used in an autonomous driving system, the solution will obviously have higher safety than simply using the road edge at the “median opening”. Compared with a conventional manner based on one side, a manner of considering statistical results of distances from the road edges on both sides of the interruption to the division line (for example, the guardrail line) at the same time has better smoothness.

As mentioned above, the reference distance may be determined based on the sampling points. Such embodiments will be described below with reference to FIGS. 3 and 4A-4D. FIG. 3 is a flowchart of a process 300 of determining a reference distance according to some embodiments of the present disclosure. The process 300 may be viewed as an implementation of step 220 in FIG. 2. FIGS. 4A-4D respectively illustrate schematic diagrams 410, 420, 430, and 440 of determining a reference distance according to some embodiments of the present disclosure.

At block 310, the computing device 102 determines a plurality of sampling points corresponding to the existing part on the map 101. The sampling points may be selected in various suitable ways. The plurality of sampling points may be determined along a specific direction of the map. For example, the sampling points may be determined along a lane line and a division line (e.g., a guardrail line).

In some embodiments, the sampling points may be determined along a lane line closest to the road edge 110. The computing device 102 may sample at a predetermined distance (e.g., 1 meter) in the traveling direction 150 along the leftmost road edge. In other words, the computing device 102 may sample every predetermined distance on the leftmost lane line of the road along the traveling direction 150, so as to obtain the distance, that is, d_gc, from relatively stable division lines at both ends of the interruption 115 to the road edge.

For example, the computing device 102 may determine a lane line (e.g., the lane line 130 illustrated in FIG. 1) that is closest to the existing part (e.g., the first segment 111 or the second segment 112) of the road. The computing device 102 may obtain a first sampling point and a second sampling point on the lane line 130. The first sampling point and the second sampling point are separated by the predetermined distance. The first sampling point and the second sampling point may be determined as start sampling points. The computing device 102 may determine sampling points other than the first sampling point and the second sampling point from the plurality of sampling points along the lane line 130 based on the first sampling point, the second sampling point, and the predetermined distance.

FIG. 4A is a schematic diagram 410 of determining sampling points according to some embodiments of the present disclosure. In the example of FIG. 4A, sampling points 401 and 402 may be determined as the first sampling point and the second sampling point, respectively. In order to determine a third sampling point 403, the computing device 102 may utilize position data of the first sampling point 401 and the second sampling point 402, a predefined arc 411, and the map 101. The position data of a sampling point may include longitude and latitude of the sampling point, and may also optionally include an altitude of the sampling point. The predefined arc 411 may have a small value, for example 0.2 degrees.

In an example process, the computing device 102 may use the position data of the first sampling point 401 and the second sampling point 402 to calculate an azimuth angle a_ab (not illustrated) of a line segment between the first sampling point 401 and the second sampling point 402. And then, the computing device 102 may calculate a point 412 having the predefined arc 411 on the left of a point at the predetermined distance in front of (relative to the traveling direction 150) the second sampling point 402 based on the azimuth angle a_ab. The computing device 102 may also calculate a point 413 having the predefined arc 411 on the right of the point at the predetermined distance in front of the second sampling point 402 based on the azimuth angle a_ab. The computing device 102 may generate a line segment between the point 412 and the point 413, and determine an intersection of the line segment and the lane line 130 in the map 101 as a next sampling point 403.

The computing device 102 may determine remaining sampling points based on a process similar to the process described with reference to FIG. 4A. Referring to FIG. 4B, FIG. 4B is a schematic diagram 420 of the determined sampling points according to some embodiments of the present disclosure. FIG. 4B illustrates the determined sampling points 401-40N on the lane line 130. In the example of FIG. 4B, the sampling points 401-40N correspond to the first segment 111 of the road edge 110, that is, the sampling points 401-40N are behind the interruption 115. It should be understood that, in some embodiments, sampling points corresponding to the second segment 112 of the road edge 110 on the lane line 130 may be determined similarly. In the process of determining the sampling points, conditions such as “a change in elevation is less than 1 m” may be used to filter out different results brought by roads in other directions in a case of a grade separation. The process of determining the sampling points described with reference to FIG. 4A is only exemplary. Other suitable manners may also be used to determine the sampling points, such as sampling directly along the lane line 130 without considering the azimuth angle.

The predetermined distance between the sampling points and a number of sampling points may be determined based on needs or application scenarios. For example, in a case where the predetermined range corresponds to 60 meters, the predetermined distance between the sampling points may be 1 meter, and the number of sampling points on one side of the interruption 115 may be 60. In other words, a total number of sampling points may be 120 when considering existing road edges on both sides of the interruption 115. However, it should be understood that numbers of sampling points on both sides of the interruption 115 may be different.

With continued reference to FIG. 3, at block 320, the computing device 102 determines a plurality of sampling distances between the existing part and the division line 120 for the plurality of sampling points (e.g., the sampling points 401-40N in FIG. 4B). In other words, the computing device 102 may determine a sampling distance corresponding to each of the plurality of sampling points.

For example, in order to determine a sampling distance corresponding to a certain sampling point in the plurality of sampling points, the computing device 102 may determine a first point corresponding to the sampling point on the existing part (for example, a part of the first segment 111) of the road edge 110, and a second point corresponding to the sampling point on the division line 120. The computing device 102 may further determine a distance between the first point and the second point as one of the plurality of sampling distances, that is, as the sampling distance corresponding to the sampling point.

FIG. 4C is a schematic diagram 430 of determining a sampling distance 433 according to some embodiments of the present disclosure. In FIG. 4C, the sampling point 403 is taken as an example to describe an example of determining the sampling distance. In order to determine the sampling distance corresponding to the sampling point 403, that is, a distance from the road edge 110 corresponding to the sampling point 403 to the division line 120. The computing device 102 may use position data (such as latitude and longitude) and orientation data (for example, an azimuth angle) of the sampling point 403, and the map 101.

The computing device 102 may determine a first point 431 corresponding to the sampling point 403 on the first segment 111 of the road edge 110, and a second point 432 corresponding to the sampling point 403 on the division line 120. An example method for determining the first point 431 and the second point 432 is illustrated. The computing device 102 may calculate a point (not illustrated) at 90 degrees to the left of the sampling point 403, and then determine a line segment from the point to the sampling point 403. An intersection point of the line segment on the map 101 with the first segment 111 of the road edge 110 (note that only an intersection point closest to the sampling point 403 is retained) may be determined as the first point 431, and an intersection point (note that only an intersection point closest to the sampling point 403 is retained) of the line segment on the map 101 with the division line 120 may be determined as the second point 432.

The computing device 102 may determine a distance between the first point 431 and the second point 432 as the sampling distance 433 corresponding to the sampling point 403. FIG. 4D is a schematic diagram 440 of the determined sampling distances according to some embodiments of the present disclosure. FIG. 4D illustrates sampling distances 431-436 corresponding to sampling points 401-406, respectively. As an example, the sampling distance 431 corresponding to the sampling point 401 may be 0.332 meters, the sampling distance 432 corresponding to the sampling point 402 may be 0.325 meters, the sampling distance 433 corresponding to the sampling point 403 may be 0.318 meters, the sampling distance 434 corresponding to the sampling point 404 may be 0.310 meters, the sampling distance 435 corresponding to the sampling point 405 may be 0.317 meters, and the sampling distance 436 corresponding to the sampling point 406 may be 0.327 meters.

It should be understood that values of the sampling distances mentioned above with reference to FIG. 4D are only illustrative and are not intended to be restrictive. In addition, the sampling points and corresponding figures of the sampling distances illustrated in FIG. 4D are for illustration only. The computing device 102 may determine corresponding sampling distances for all the determined sampling points, that is, distances from road edges corresponding to the sampling points to the division line.

With continued reference to FIG. 3, at block 330, the computing device 102 determines an average value of the plurality of sampling distances as the reference distance. FIG. 5 is a schematic diagram 500 of generating a supplementary part according to some embodiments of the present disclosure. In the example of FIG. 5, the plurality of sampling points determined at step 310 includes a first set of sampling points 510 behind the interruption 115 and a second set of sampling points 520 in front of the interruption 115. The first set of sampling points 510 and the second set of sampling points 520 may have the same or different number of sampling points, and each sampling point has a corresponding sampling distance as described with reference to, for example, step 220. The computing device 102 may calculate the average value of the sampling distances corresponding to the plurality of sampling points as the reference distance (for example, a reference distance 550 illustrated in FIG. 5).

For example, a distance from an average division line of the sampling points in the first set of sampling points 510 to the road edge is bw_avg, and a distance from an average division line of the sampling points in the second set of sampling points 510 to the road edge is fw_avg. A distance from the division line to the road edge for the interruption 115 is an average value of forward and backward directions, that is, d_gc_opening=(bw_avg+fw_avg)/2. D_gc_opening here may refer to the reference distance described above.

Some embodiments of determining the distance from the division line to the road edge for the interruption based on the sampling points have been described above with reference to FIGS. 3 and 4A-4D. As mentioned above with reference to step 230, the supplementary part for the interruption 115 may be generated based on fitting points. For example, the fitting points may be calculated based on the reference distance determined in step 220 and points on the division line 120 corresponding to the interruption 115, thereby generating the supplementary part. Functions such as st_project( ) function in a spatial database may be used to obtain the fitting points.

Some embodiments of generating the supplementary part are described below with continued reference to FIG. 5. The generation of the supplementary part described with reference to FIG. 5 may be regarded as a specific implementation of step 230. The computing device 102 may determine a plurality of reference points corresponding to the interruption 115 on the division line 120, such as a reference point 502 illustrated in FIG. 5. The reference points on the division line 120 may be determined in various ways. As an example, the computing device 102 may sample on a part of the division line 120 corresponding to the interruption 115 to obtain the reference points.

As another example, the computing device 102 may determine the reference points with other information, for example, the sampling points on the lane line 130. As illustrated in FIG. 5, in addition to the first set of sampling points 510 and the second set of sampling points 520, the computing device 102 may also determine an additional sampling point on the lane line 130, for example, a sampling point 501. And then, the computing device 102 may determine a sampling point 502 corresponding to the sampling point 501 on the division line 120. The determination of the sampling point 502 is similar to the manner of determining the point 432 described above with reference to FIG. 4C.

After the reference points are determined, the computing device 102 may determine a plurality of supplementary points, for example, supplementary points 503, 504 and 505 as illustrated in FIG. 5, between the division line 120 and the lane line 130 of the road based on the determined plurality of reference points and the reference distance. For example, the supplementary points may be determined by extending, from the reference points, toward the inside of the road by the reference distance. Illustratively, the supplementary point 503 may be determined by extending, from the reference point 502, toward the inside of the road by the reference distance 550.

The computing device 102 generates the supplementary part of the road edge 110 by connecting a plurality of supplementary points (for example, including the supplementary points 503, 504, and 505). In some embodiments, the computing device 102 may directly connect the determined plurality of supplementary points as the supplementary part of the road edge 110. In some embodiments, the computing device 102 may utilize a tool such as a fitting function to connect the supplementary points. The supplementary part generated in this way is smooth.

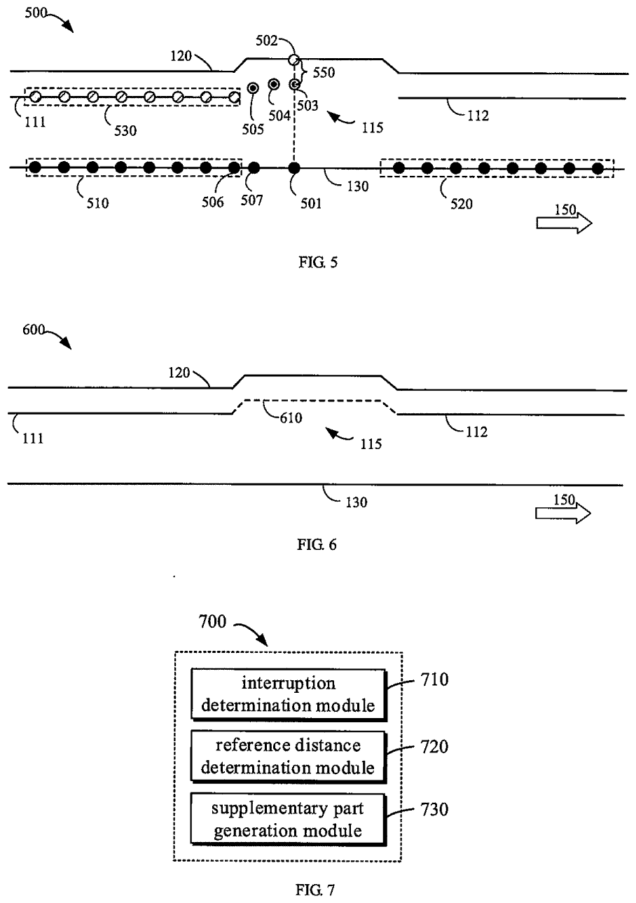

FIG. 6 is a schematic diagram 600 of an updated map according to some embodiments of the present disclosure. FIG. 6 illustrates a part of an updated version of the map 101 illustrated in FIG. 1. A supplementary part 610 of the road edge 110 is illustrated in dashed lines.

For example, road edges on two sides of the “median opening” are likely to be affected by recognition algorithms and manual operations, resulting in large errors or even mistakes. Some embodiments according to the present disclosure may also be used for quality inspection of the road edges on two sides of an opening to improve the overall quality of the high-definition map. Hereinafter, such an embodiment will be described with continued reference to FIG. 5.

The computing device 102 may determine a dispersion degree of a distance between the existing part of the road edge 110 and the division line 120 in at least a part of the plurality of sampling points. For example, when quality inspection is to be performed on the first segment 111 (i.e., the road edge behind the interruption 115), the dispersion degree may be determined based on the sampling distances (e.g., reference may be made to FIG. 4D) corresponding to each sampling point in the first set of sampling points 510. For example, a standard deviation sigma of the sampling distances is determined.

The computing device 102 may determine a distance threshold for a potential error in the road edge based on the dispersion degree. As an example, the distance threshold may be, for example, a multiple of the standard deviation sigma, such as 3*sigma. As another example, the distance threshold may further consider an average of the sampling distances.

The computing device 102 may provide information related to the potential error based on the distance threshold. For example, the computing device 102 may calculate a distance from a point in a set of points 530 on the first segment 111 of the road edge 110 to the division line 120. If the distance exceeds the distance threshold, it may be considered that a large error may exist in the drawing of a corresponding point or a nearby road edge. In this case, the computing device 102 may provide (e.g., input via a user interface) information related to the potential error, such as an identification or position data of a point where the potential error exists, a distance from the point to the division line 120, and the distance threshold. In some embodiments, the quality inspection may be performed only for a part closest to the interruption 115 (for example, a point 506 illustrated in FIG. 5).

In some embodiments, the computing device 102 may also carry out the quality inspection by considering a difference of distances from the road edge to the division line between two points. As an example, the computing device 102 may read a sample of a map to be inspected and determine a sampling point of a first non-opening segment behind an opening segment, such as the sampling point 506 behind the interruption 115 illustrated in FIG. 5. The computing device 102 may determine a sampling point of a first opening segment, such as a sampling point 507 illustrated in FIG. 5.

The computing device 102 may determine a certain number of sampling points extending by the predetermined distance from the sampling point 506 to the rear, for example, sampling points in the first set of sampling points 510. And then, the standard deviations sigma of distances from the road edge 110 to the division line 120 may be calculated for the sampling points. The computing device 102 may determine whether a distance from a part of the road edge 110 between the sampling point 506 and the sampling point 507 to the division line 120 exceeds, for example, 3*sigma. If the distance exceeds 3*sigma, it may be considered that a potential error may exist in a part of the road edge 110 corresponding to the sampling point 506 or the sampling point 507, such as a drawing error. In this case, the computing device 102 may provide information about the potential error as a quality inspection result. For example, the identification of the sampling point, a threshold or standard used, and a distance from a corresponding road edge to the division line may be provided.

In such an embodiment, the solution of the present disclosure may be used for quality inspection of the map, thereby helping to improve the accuracy of the high-definition map.

FIG. 7 is a block diagram of a map updating apparatus 700 according to some embodiments of the present disclosure. The apparatus 700 may be included in the computing device 102 in FIG. 1, or implemented as the computing device 102. As illustrated in FIG. 7, the apparatus 700 includes an interruption determination module 710. The interruption determination module 710 is configured to determine that there is an interruption on a road edge of a road on a map. The road edge represents a boundary of a part of the road available for vehicles. The apparatus 700 includes a reference distance determination module 720. The reference distance determination module 720 is configured to determine, based on the map, a reference distance between an existing part of the road edge and a division line. The existing part is within a predetermined distance from the interruption. The division line represents a division between different traveling directions of the road. The apparatus 700 includes a supplementary part generation module 730. The supplementary part generation module 730 is configured to generate a supplementary part for the interruption on the map based on the reference distance and the division line.

In some embodiments, the reference distance determination module 720 includes a sampling point determination module, a sampling distance determination module and an average value determination module. The sampling point determination module is configured to determine a plurality of sampling points corresponding to the existing part on the map. The sampling distance determination module is configured to, for the plurality of sampling points, determine a plurality of sampling distances between the existing part and the division line. The average value determination module is configured to determine an average value of the plurality of sampling distances as the reference distance.

In some embodiments, the sampling point determination module includes a lane line determination module, a start sampling point obtaining module, and a sampling point calculation module. The lane line determination module is configured to determine a lane line of the road closest to the existing part. The start sampling point obtaining module is configured to obtain a first sampling point and a second sampling point on the lane line. The first sampling point and the second sampling point are spaced by a predetermined distance. The sampling point calculation module is configured to determine, based on the first sampling point, the second sampling point and the predetermined distance, sampling points other than the first sampling point and the second sampling point from the plurality of sampling points along the lane line.

In some embodiments, the sampling distance determination module includes a first point determination module, a second point determination module, and a distance calculation module. The first point determination module is configured to determine a first point corresponding to a third sampling point in the plurality of sampling points from the existing part. The second point determination module is configured to determine a second point corresponding to the third sampling point on the division line. The distance calculation module is configured to determine a distance between the first point and the second point as one of the plurality of sampling distances.

In some embodiments, the existing part includes a first part and a second part. The first part is located behind the interruption along a traveling direction of the road. The second part is located in front of the interruption along the traveling direction of the road.

In some embodiments, the supplementary part generation module 730 includes a reference point determination module, a supplementary point determination module, and a supplementary point connection module. The reference point determination module is configured to determine a plurality of reference points corresponding to the interruption on the division line. The supplementary point determination module is configured to determine a plurality of supplementary points between the division line and a lane line of the road based on the plurality of reference points and the reference distance. The supplementary point connection module is configured to generate the supplementary part by connecting the plurality of supplementary points.

In some embodiments, the apparatus 700 further includes a dispersion degree determination module, a distance threshold determination module, and an information providing module. The dispersion degree determination module is configured to determine a dispersion degree of a distance between the existing part and the division line in at least a part of the plurality of sampling points. The distance threshold determination module is configured to determine a distance threshold for a potential error in the road edge based on the dispersion degree. The information providing module is configured to provide information related to the potential error based on the distance threshold.

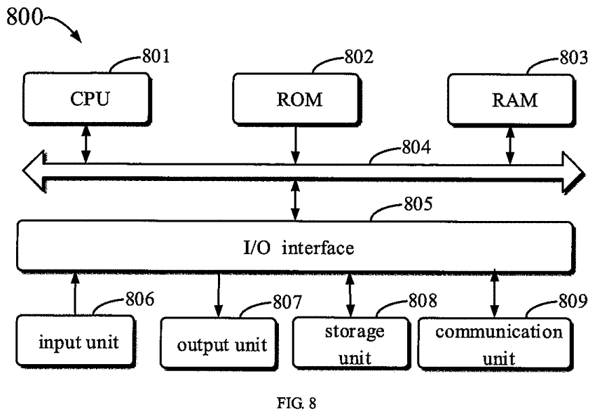

FIG. 8 is a block diagram of an example device 800 capable of implementing various embodiments of the present disclosure. The device 800 may be configured to implement the computing device 102 as described in FIG. 1. As illustrated in the figure, the device 800 includes a central processing unit (CPU) 801, which may perform various suitable actions and processes in accordance with computer program instructions stored in a read only memory (ROM) 802 or loaded from a storage unit 808 into a random access memory (RAM) 803. In the RAM 803, various programs and data necessary for operations of the device 800 may also be stored. The CPU 801, the ROM 802, and the RAM 803 are connected to each other through a bus 804. An input/output (I/O) interface 805 is also connected to the bus 804.

A number of components in the device 800 are connected to the I/O interface 805, including: an input unit 806 such as a keyboard, a mouse, and the like; an output unit 807 such as various types of displays, speakers, etc.; the storage unit 808 such as a magnetic disk, an optical disk, or the like; and a communication unit 809 such as a network card, a modem, a wireless communication transceiver, and so on. The communication unit 809 allows the device 800 to exchange information/data with other devices via a computer network such as the Internet and/or various telecommunications networks.

The processing unit 801 performs the various methods and processes described above, such as any one of the processes 200 and 300. For example, in some embodiments, any one of the processes 200 and 300 may be implemented as a computer software program tangibly embodied on a machine-readable medium, such as the storage unit 808. In some embodiments, some or all of the computer programs may be loaded and/or installed onto the device 800 via the ROM 802 and/or the communication unit 809. When a computer program is loaded onto the RAM 803 and executed by the CPU 801, one or more steps in any one of the processes 200 and 300 described above may be performed. Alternatively, in other embodiments, the CPU 801 may be configured to perform any one of the processes 200 and 300 in any other suitable manner (e.g., by way of the firmware).

The functions described herein above may be performed, at least in part, by one or more hardware logic components. For example, and without limitation, exemplary types of the hardware logic components that may be used include: a field programmable gate array (FPGA), an application specific integrated circuit (ASIC), an application specific standard product (ASSP), a system on chip (SOC), a complex programmable logic device (CPLD), and the like.

Program codes for performing the method in the present disclosure may be written in any combination of one or more programming languages. These program codes may be provided to a processor or controller in a general-purpose computer, a special purpose computer, or other programmable data processing devices, such that the program codes, when executed by the processor or controller, are configured to implement functions/operations specified in the flow chart and/or block diagrams. The program code may be executed entirely on a machine, partly on the machine, as a separate software package, partly on the machine, partly on a remote computer, or entirely on the remote computer or server.

In the context of the present disclosure, the machine-readable medium may be a tangible medium that may contain, or store a program for use by or in combination with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include: an electrical connection having one or more wires, a portable computer disk, a hard disk, a random access memory (RAM), a read only memory (ROM), an Erasable Programmable Read Only Memory (EPROM or a flash memory), an optical fiber, a compact disc read-only memory (CD-ROM), an optical memory component, a magnetic memory component, or any suitable combination thereof.

Moreover, while operations are described in a particular order, this should be understood as that the operations are required to be performed in a particular illustrated order or in a sequential order, or that all illustrated operations are required to be performed to achieve desirable results. In certain circumstances, multitasking and parallel processing may be advantageous. Likewise, while several specific implementation details are included in the above discussion, these should not be construed as limiting the scope of the present disclosure. Certain features described in the context of separate embodiments may also be implemented in combination in a single implementation. Conversely, features that are described in the context of the single implementation may also be implemented in a plurality of implementations separately or in any suitable sub-combination.

Although the subject matter has been described in a language specific to structural features and/or methodological acts, it is to be understood that the subject matter defined in the attached claims is not necessarily limited to the specific features or acts described above. Instead, the specific features and acts described above are merely exemplary forms for implementing the attached claims.

What is claimed is:

1. A map updating method, comprising:
determining that there is an interruption on a road edge of a road on a map, the road edge representing a boundary of a part of the road available for vehicles;
determining, based on the map, a reference distance between an existing part of the road edge and a division line, the existing part being within a predetermined distance from the interruption, and the division line representing a division between different traveling directions of the road; and
generating a supplementary part for the interruption on the map based on the reference distance and the division line.

2. The method of claim 1, wherein determining the reference distance comprises:
determining a plurality of sampling points corresponding to the existing part on the map;
for the plurality of sampling points, determining a plurality of sampling distances between the existing part and the division line; and
determining an average value of the plurality of sampling distances as the reference distance.

3. The method of claim 2, wherein determining the plurality of sampling points comprises:
determining a lane line of the road closest to the existing part;
obtaining a first sampling point and a second sampling point on the lane line, the first sampling point and the second sampling point being spaced by a predetermined distance; and
determining, based on the first sampling point, the second sampling point and the predetermined distance, sampling points other than the first sampling point and the second sampling point from the plurality of sampling points along the lane line.

4. The method of claim 2, wherein determining the plurality of sampling distances comprises:
determining a first point corresponding to a third sampling point in the plurality of sampling points from the existing part;
determining a second point corresponding to the third sampling point on the division line; and
determining a distance between the first point and the second point as one of the plurality of sampling distances.

5. The method of claim 1, wherein the existing part comprises a first part and a second part, the first part being located behind the interruption along a traveling direction of the road, and the second part being located in front of the interruption along the traveling direction of the road.

6. The method of claim 1, wherein generating the supplementary part comprises:
determining a plurality of reference points corresponding to the interruption on the division line;
determining a plurality of supplementary points between the division line and a lane line of the road based on the plurality of reference points and the reference distance; and
generating the supplementary part by connecting the plurality of supplementary points.

7. The method of claim 2, further comprising:
determining a dispersion degree of a distance between the existing part and the division line in at least a part of the plurality of sampling points;
determining a distance threshold for a potential error in the road edge based on the dispersion degree; and
providing information related to the potential error based on the distance threshold.

8. A map updating apparatus, comprising:
one or more processors;
a memory storing instructions executable by the one or more processors;
wherein the one or more processors are configured to:
determine that there is an interruption on a road edge of a road on a map, the road edge representing a boundary of a part of the road available for vehicles;
determine, based on the map, a reference distance between an existing part of the road edge and a division line, the existing part being within a predetermined distance from the interruption, and the division line representing a division between different traveling directions of the road; and
generate a supplementary part for the interruption on the map based on the reference distance and the division line.

9. The apparatus of claim 8, wherein the one or more processors are configured to:
determine a plurality of sampling points corresponding to the existing part on the map;
for the plurality of sampling points, determine a plurality of sampling distances between the existing part and the division line; and
determine an average value of the plurality of sampling distances as the reference distance.

10. The apparatus of claim 9, wherein the one or more processors are configured to:
determine a lane line of the road closest to the existing part;
obtain a first sampling point and a second sampling point on the lane line, the first sampling point and the second sampling point being spaced by a predetermined distance; and
determine, based on the first sampling point, the second sampling point and the predetermined distance, sampling points other than the first sampling point and the second sampling point from the plurality of sampling points along the lane line.

11. The apparatus of claim 9, wherein the one or more processors are configured to:
determine a first point corresponding to a third sampling point in the plurality of sampling points from the existing part;
determine a second point corresponding to the third sampling point on the division line; and
determine a distance between the first point and the second point as one of the plurality of sampling distances.

12. The apparatus of claim 8, wherein the existing part comprises a first part and a second part, the first part being located behind the interruption along a traveling direction of the road, and the second part being located in front of the interruption along the traveling direction of the road.

13. The apparatus of claim 8, wherein the one or more processors are configured to:
determine a plurality of reference points corresponding to the interruption on the division line;
determine a plurality of supplementary points between the division line and a lane line of the road based on the plurality of reference points and the reference distance; and
generate the supplementary part by connecting the plurality of supplementary points.

14. The apparatus of claim 9, wherein the one or more processors are configured to:
determine a dispersion degree of a distance between the existing part and the division line in at least a part of the plurality of sampling points;
determine a distance threshold for a potential error in the road edge based on the dispersion degree; and
provide information related to the potential error based on the distance threshold.

15. A non-transitory computer-readable storage medium having a computer program stored thereon, wherein when the program is executed by a processor, a map updating method is implemented, and the method comprises:
determining that there is an interruption on a road edge of a road on a map, the road edge representing a boundary of a part of the road available for vehicles;
determining, based on the map, a reference distance between an existing part of the road edge and a division line, the existing part being within a predetermined distance from the interruption, and the division line representing a division between different traveling directions of the road; and
generating a supplementary part for the interruption on the map based on the reference distance and the division line.
